(19) United States
(12) Patent Application Publication
(10) Pub. No.: US 2021/0215506 A1
(43) Pub. Date: Jul. 15, 2021

(54) VEHICLE SENSOR SELF-CALIBRATION VIA TEST VEHICLES

(71) Applicant: TOYOTA MOTOR NORTH AMERICA, INC., Plano, TX (US)

(72) Inventor: Ryan M. Wiesenberg, Ann Arbor, MI (US)

(21) Appl. No.: 16/741,731

(22) Filed: Jan. 13, 2020

(51) Int. Cl. G01C 25/00; G01M 17/007

(52) U.S. Cl. CPC G01C 25/005; G01M 17/0074

(57) ABSTRACT

An example operation includes one or more of determining a test vehicle in motion is proximate to a transport-under-test in motion, wherein the test vehicle includes a calibration device, and the transport-under-test includes one or more sensors, transmitting calibration results from the calibration device to the one or more sensors, receiving a calibration result, via the calibration device, from the one or more sensors, determining, via the test vehicle, an error with the one or more sensors based on the calibration result and calibrating, via the transport-under-test, the one or more sensors based on the error.

### TECHNICAL FIELD

This application generally relates to vehicle sensor calibration, and more particularly, to vehicle sensor self-calibration via test vehicles.

### BACKGROUND

Vehicles or transports, such as cars, motorcycles, trucks, planes, trains, etc., generally provide transportation needs to occupants and/or goods in a variety of ways. Functions related to transports may be identified and utilized by various computing devices, such as a smartphone or a computer.

Currently, sensors are manually calibrated during a manufacturing process by positioning the transport within a warehouse facility capable of housing both the transport and the calibration equipment. A transport operator manually inputs calibration-related information to calibrate the sensors coupled to the transport.

Self-calibration of the sensors is preferable to manual calibration as it may be faster, less prone to human error, be more accurate and repeatable. Additionally, calibrating the sensors in a less capital-intensive manner that does not require dedicated warehouse space may allow a cost savings and may allow calibration in conditions more closely simulating actual driving scenarios.

### SUMMARY

One example embodiment provides a method, comprising one or more of determining a test vehicle in motion is proximate to a transport-under-test in motion, wherein the test vehicle includes a calibration device, and the transport-under-test includes one or more sensors, transmitting calibration results from the calibration device to the one or more sensors, receiving a calibration result, via the calibration device, from the one or more sensors, determining, via the test vehicle, an error with the one or more sensors based on the calibration result and calibrating, via the transport-under-test, the one or more sensors based on the error.

Another example embodiment provides a system, comprising one or more of a test vehicle including a calibration device, a transport-under-test including one or more sensors, a proximity detector electrically coupled with the transport-under-test, that determines the test vehicle in motion is proximate to the transport-under-test in motion, a transmitter responsive to the calibration device, that transmits a calibration result to the one or more sensors and a receiver responsive to the one or more sensors, that receives the calibration result, via the calibration device, wherein the test vehicle determines an error with the one or more sensors based on the calibration result and wherein the transport-under-test calibrates the one or more sensors based on the error.

A further example embodiment provides a non-transitory computer readable medium comprising instructions, that when read by a processor, cause the processor to perform one or more of determining a test vehicle in motion is proximate to a transport-under-test in motion, wherein the test vehicle includes a calibration device, and the transport-under-test includes one or more sensors, transmitting a calibration result from the calibration device to the one or more sensors, receiving the calibration result, via the calibration device, from the one or more sensors, determining, via the test vehicle, an error with the one or more sensors based on the calibration result and calibrating, via the transport-under-test, the one or more sensors based on the error.

### BRIEF DESCRIPTION OF THE DRAWINGS

FIG. 1A illustrates a first example test vehicle and transport-under-test, according to example embodiments.

FIG. 1B illustrates a second example test vehicle and transport-under-test, according to example embodiments.

FIG. 1C illustrates an example fixed location calibration device and a mobile location calibration device, according to example embodiments.

FIG. 1D illustrates an example calibration rig and calibration device mounted to the transport-under-test, according to example embodiments.

FIG. 1E illustrates an example connecting and communication system for the calibration rig mounted to the transport-under-test, according to example embodiments.

FIG. 2A illustrates a transport network diagram, according to example embodiments.

FIG. 2B illustrates another transport network diagram, according to example embodiments.

FIG. 2C illustrates yet another transport network diagram, according to example embodiments.

FIG. 2D illustrates a further transport network diagram, according to example embodiments.

FIG. 3 illustrates a flow diagram, according to example embodiments.

FIG. 4 illustrates a machine learning transport network diagram, according to example embodiments.

FIG. 5A illustrates an example vehicle configuration for managing database transactions associated with a vehicle, according to example embodiments.

FIG. 5B illustrates another example vehicle configuration for managing database transactions conducted among various vehicles, according to example embodiments

FIG. 6A illustrates a blockchain architecture configuration, according to example embodiments.

FIG. 6B illustrates another blockchain configuration, according to example embodiments.

FIG. 6C illustrates a blockchain configuration for storing blockchain transaction data, according to example embodiments.

FIG. 6D illustrates example data blocks, according to example embodiments.

FIG. 7 illustrates an example system that supports one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout least this specification refers to the fact that a particular feature, structure, or characteristic described in connection with the embodiment may be included in at one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments. In the diagrams, any connection between elements can permit one-way and/or two-way communication even if the depicted connection is a one-way or two-way arrow. In the current application, a transport may include one or more of cars, trucks, motorcycles, scooters, bicycles, boats, recreational vehicles, planes, and any object that may be used to transport people and or goods from one location to another.

In addition, while the term “message” may have been used in the description of embodiments, the application may be applied to many types of network data, such as, a packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

Example embodiments provide methods, systems, components, non-transitory computer readable media, devices, and/or networks, which provide at least one of: a transport (also referred to as a vehicle herein) a data collection system, a data monitoring system, a verification system, an authorization system and a vehicle data distribution system. The vehicle status condition data, received in the form of communication update messages, such as wireless data network communications and/or wired communication messages, may be received and processed to identify vehicle/transport status conditions and provide feedback as to the condition changes of a transport. In one example, a user profile may be applied to a particular transport/vehicle to authorize a current vehicle event, service stops at service stations, and to authorize subsequent vehicle rental services.

Within the communication infrastructure, a decentralized database is a distributed storage system which includes multiple nodes that communicate with each other. A blockchain is an example of a decentralized database which includes an append-only immutable data structure (i.e. a distributed ledger) capable of maintaining records between untrusted parties. The untrusted parties are referred to herein as peers, nodes or peer nodes. Each peer maintains a copy of the database records and no single peer can modify the database records without a consensus being reached among the distributed peers. For example, the peers may execute a consensus protocol to validate blockchain storage entries, group the storage entries into blocks, and build a hash chain via the blocks. This process forms the ledger by ordering the storage entries, as is necessary, for consistency. In a public or permissionless blockchain, anyone can participate without a specific identity. Public blockchains can involve cryptocurrencies and use consensus based on various protocols such as proof of work (PoW). On the other hand, a permissioned blockchain database provides a system which can secure interactions among a group of entities which share a common goal, but which do not or cannot fully trust one another, such as businesses that exchange funds, goods, information, and the like. The instant application can function in a permissioned and/or a permissionless blockchain setting.

Smart contracts are trusted distributed applications which leverage tamper-proof properties of the shared or distributed ledger (i.e., which may be in the form of a blockchain) database and an underlying agreement between member nodes which is referred to as an endorsement or endorsement policy. In general, blockchain entries are “endorsed” before being committed to the blockchain while entries which are not endorsed are disregarded. A typical endorsement policy allows smart contract executable code to specify endorsers for an entry in the form of a set of peer nodes that are necessary for endorsement. When a client sends the entry to the peers specified in the endorsement policy, the entry is executed to validate the entry. After validation, the entries enter an ordering phase in which a consensus protocol is used to produce an ordered sequence of endorsed entries grouped into blocks.

Nodes are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node which submits an entry-invocation to an endorser (e.g., peer), and broadcasts entry-proposals to an ordering service (e.g., ordering node). Another type of node is a peer node which can receive client submitted entries, commit the entries and maintain a state and a copy of the ledger of blockchain entries. Peers can also have the role of an endorser, although it is not a requirement. An ordering-service-node or orderer is a node running the communication service for all nodes, and which implements a delivery guarantee, such as a broadcast to each of the peer nodes in the system when committing entries and modifying a world state of the blockchain, which is another name for the initial blockchain entry which normally includes control and setup information.

A ledger is a sequenced, tamper-resistant record of all state transitions of a blockchain. State transitions may result from smart contract executable code invocations (i.e., entries) submitted by participating parties (e.g., client nodes, ordering nodes, endorser nodes, peer nodes, etc.). An entry may result in a set of asset key-value pairs being committed to the ledger as one or more operands, such as creates, updates, deletes, and the like. The ledger includes a blockchain (also referred to as a chain) which is used to store an immutable, sequenced record in blocks. The ledger also includes a state database, which maintains a current state of the blockchain. There is typically one ledger per channel. Each peer node maintains a copy of the ledger for each channel of which they are a member.

A chain is an entry log which is structured as hash-linked blocks, and each block contains a sequence of N entries where N is equal to or greater than one. The block header includes a hash of the block's entries, as well as a hash of the prior block's header. In this way, all entries on the ledger may be sequenced and cryptographically linked together. Accordingly, it is not possible to tamper with the ledger data without breaking the hash links. A hash of a most recently added blockchain block represents every entry on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys that are included in the chain entry log. Because the current state represents the latest key values known to a channel, it is sometimes referred to as a world state. Smart contract executable code invocations execute entries against the current state data of the ledger. To make these smart contract executable code interactions efficient, the latest values of the keys may be stored in a state database. The state database may be simply an indexed view into the chain's entry log, it can therefore be regenerated from the chain at any time. The state database may automatically be recovered (or generated if needed) upon peer node startup, and before entries are accepted.

A blockchain is different from a traditional database in that the blockchain is not a central storage but rather a decentralized, immutable, and secure storage, where nodes must share in changes to records in the storage. Some properties that are inherent in blockchain and which help implement the blockchain include, but are not limited to, an immutable ledger, smart contracts, security, privacy, decentralization, consensus, endorsement, accessibility, and the like.

Example embodiments provide a way for providing a vehicle service to a particular vehicle and/or requesting user associated with a user profile that is applied to the vehicle. For example, a user may be the owner of a vehicle or the operator of a vehicle owned by another party. The vehicle may require service at certain intervals and the service needs may require authorization prior to permitting the services to be received. Also, service centers may offer services to vehicles in a nearby area based on the vehicle's current route plan and a relative level of service requirements (e.g., immediate, severe, intermediate, minor, etc.). The vehicle needs may be monitored via one or more sensors which report sensed data to a central controller computer device in the vehicle, which in turn, is forwarded to a management server for review and action.

A sensor may be located on one or more of the interior of the transport, the exterior of the transport, on a fixed object apart from the transport, and on another transport near to the transport. The sensor may also be associated with the transport's speed, the transport's braking, the transport's acceleration, fuel levels, service needs, the gear-shifting of the transport, the transport's steering, and the like. The notion of a sensor may also be a device, such as a mobile device. Also, sensor information may be used to identify whether the vehicle is operating safely and whether the occupant user has engaged in any unexpected vehicle conditions, such as during the vehicle access period. Vehicle information collected before, during and/or after a vehicle's operation may be identified and stored in a transaction on a shared/distributed ledger, which may be generated and committed to the immutable ledger as determined by a permission granting consortium, and thus in a “decentralized” manner, such as via a blockchain membership group. Each interested party (i.e., company, agency, etc.) may want to limit the exposure of private information, and therefore the blockchain and its immutability can limit the exposure and manage permissions for each particular user vehicle profile. A smart contract may be used to provide compensation, quantify a user profile score/rating/review, apply vehicle event permissions, determine when service is needed, identify a collision and/or degradation event, identify a safety concern event, identify parties to the event and provide distribution to registered entities seeking access to such vehicle event data. Also, the results may be identified, and the necessary information can be shared among the registered companies and/or individuals based on a “consensus” approach associated with the blockchain. Such an approach could not be implemented on a traditional centralized database.

Every autonomous driving system is built on a whole suite of software and an array of sensors. Machine learning, light detection and ranging (LIDAR) projectors, radar, and ultrasonic sensors all work together to create a living map of the world that a self-driving car can navigate. Most companies in the race to full autonomy are relying on the same basic technological foundations of lidar+radar+cameras+ultrasonic, with a few notable exceptions.

In another embodiment, global position system (GPS), maps and other cameras and sensors are used in an autonomous vehicles without lidar as lidar is often viewed as being expensive and unnecessary. Researchers have determined that stereo cameras are a low-cost alternative to the more expensive lidar functionality.

The instant application includes, in certain embodiments, authorizing a vehicle for service via an automated and quick authentication scheme. For example, driving up to a charging station or fuel pump may be performed by a vehicle operator and the authorization to receive charge or fuel may be performed without any delays provided the authorization is received by the service station. A vehicle may provide a communication signal that provides an identification of a vehicle that has a currently active profile linked to an account that is authorized to accept a service which can be later rectified by compensation. Additional measures may be used to provide further authentication, such as another identifier may be sent from the user's device wirelessly to the service center to replace or supplement the first authorization effort between the transport and the service center with an additional authorization effort.

Data shared and received may be stored in a database which maintains data in one single database (e.g., database server) and generally at one particular location. This location is often a central computer, for example, a desktop central processing unit (CPU), a server CPU, or a mainframe computer. Information stored on a centralized database is typically accessible from multiple different points. A centralized database is easy to manage, maintain, and control, especially for purposes of security because of its single location. Within a centralized database, data redundancy is minimized as a single storing place of all data also implies that a given set of data only has one primary record.

The local environment of the calibration may be divided into one of two domains, a static domain and a mobile domain. Within the static domain, the calibration devices themselves may be placed on a calibration rig on the transport-under-test itself or may be fixed to a stationary structure such as a light pole, street sign, crossing light and the like. Within the mobile domain, the calibration devices may be placed on another vehicle such as a test-vehicle or may be placed on a pedestrian such as in a crosswalk or on a bicycle. In both the static and mobile domain tests, the calibration region is one that reflects an actual driving scenario.

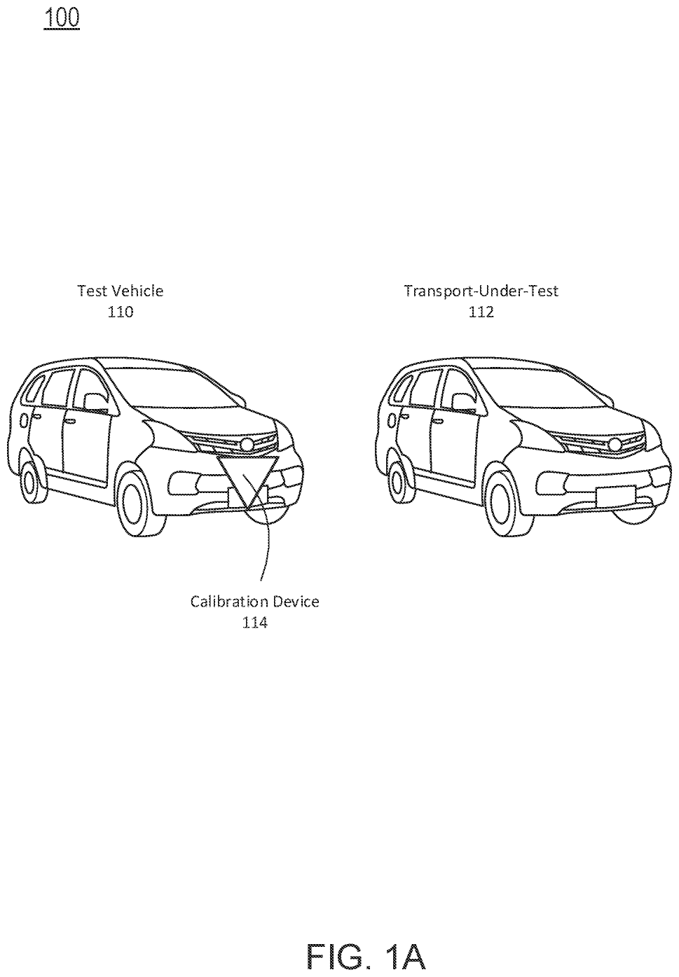

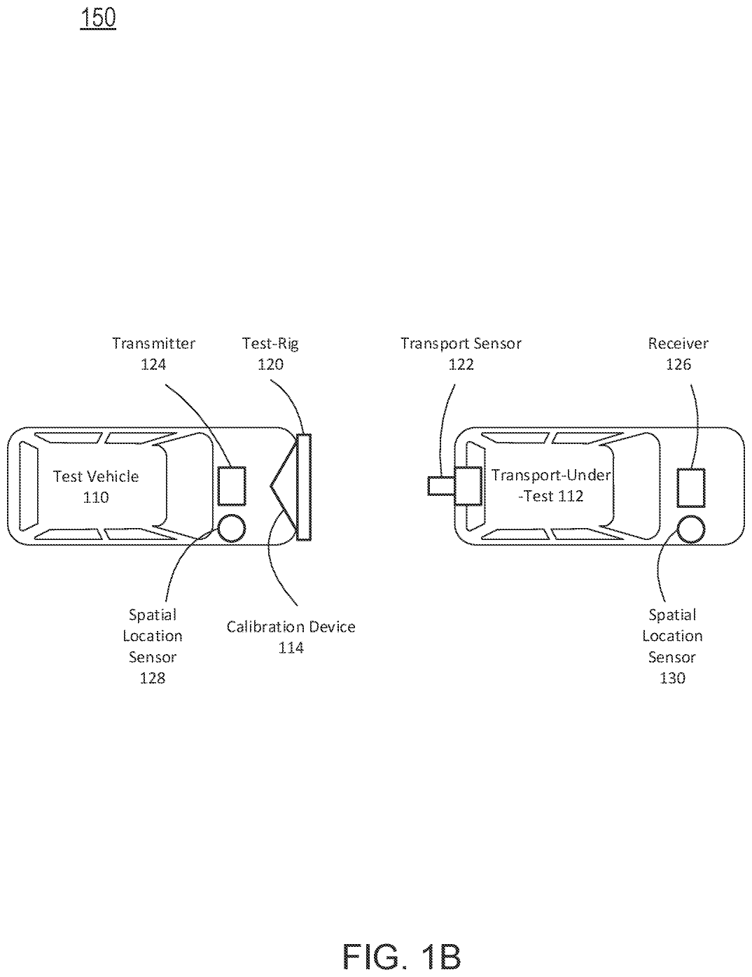

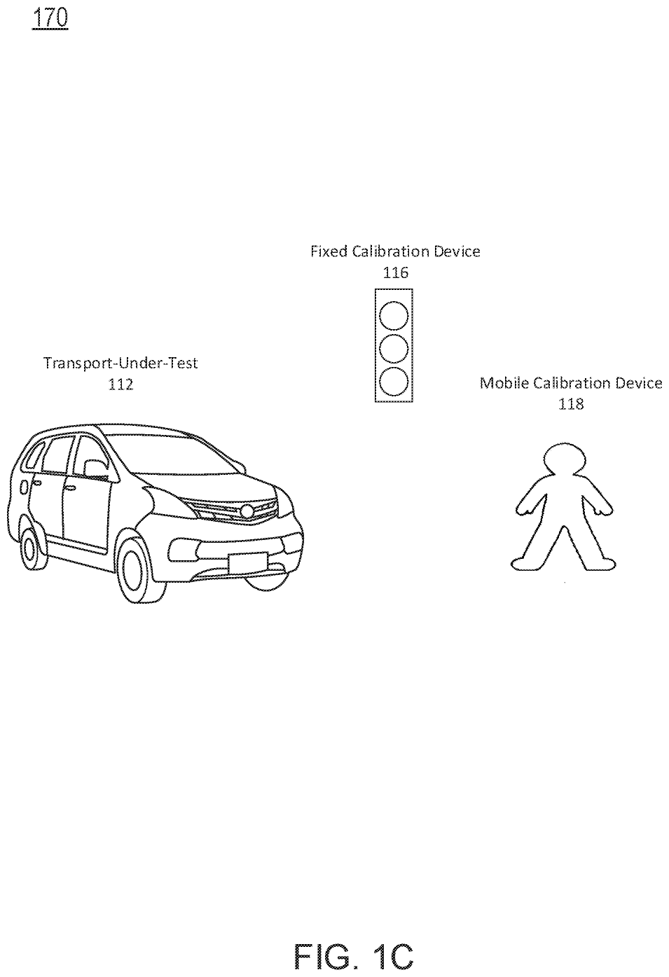

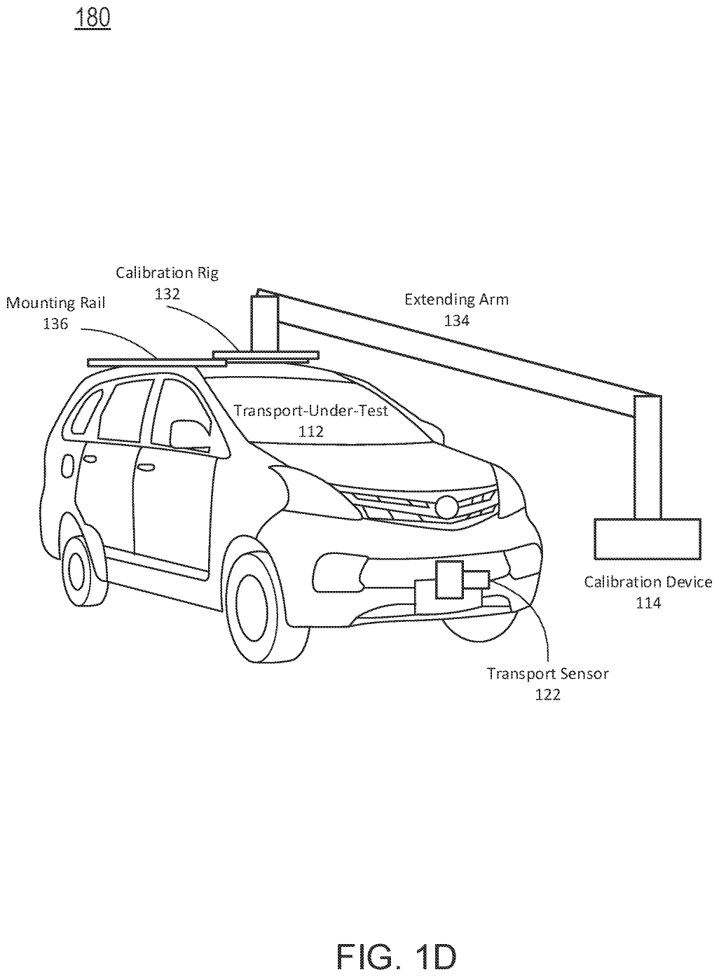

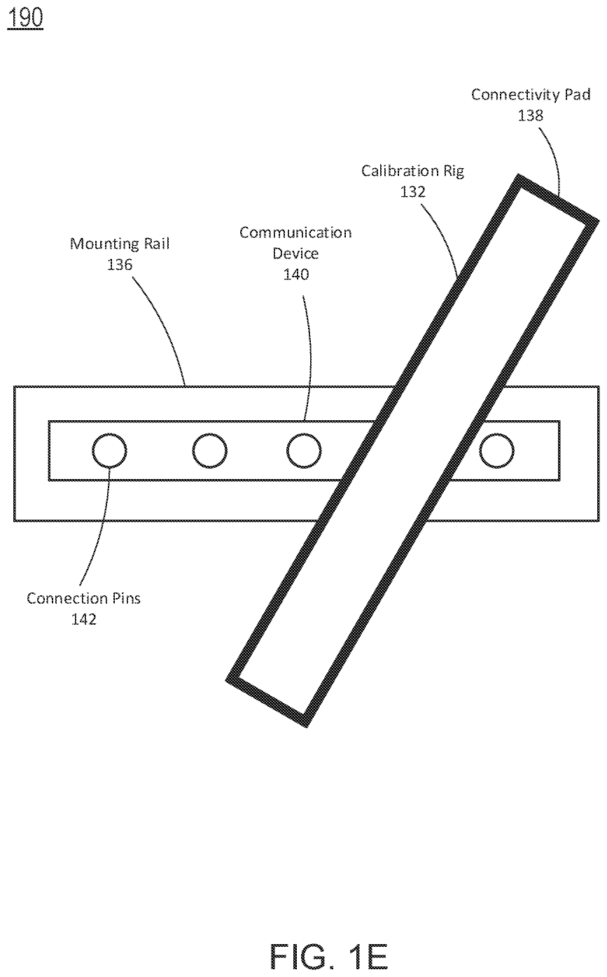

FIG. 1A illustrates an example system 100 of the present disclosure, which provides sensor self-calibration systems for a transport-under-test 112 via a test vehicle 110 wherein the test vehicle, which is mobile in nature, may perform calibration testing at multiple locations or perform testing while the transport-under-test is in motion, or both the test vehicle and the transport-under-test may be in motion.

This embodiment provides a system capable of performing self-calibration of one or more sensors at multiple locations, or when the transport-under-test is in motion as a test vehicle equipped with the calibration testing devices which performs the testing.

In one embodiment, a transport-under-test is calibrated utilizing a test vehicle. The test vehicle 110 is equipped with calibration equipment and may be behind, in front of, on the side of the transport-under-test 112. The transport-under-test is able to test sensors such as light detection and ranging (LIDAR), cameras, proximity sensors, infrared imaging detectors, radar and the like, utilizing calibration devices that may include devices such as a trihedral corner reflector, a camera calibration image, a lateral pad and the like.

Sensors on a transport-under-test are tested by the test vehicle, which may be moving down a highway, for example. Calibration data is then provided to transport-under-test. For example, Toyota may have a test vehicle, whose core function is to test sensors of a particular fleet or group of transports at multiple locations, or while in motion.

The calibration data from the test vehicle 110 and the transport-under-test 112 is sent to a server where the calibration data is stored in a blockchain. The vehicle may be monitored via one or more sensors that report sensed data to a central controller computer device, which in turn, is forwarded to a blockchain and/or a management server for review and action. Additionally, the blockchain may be in a server outside of the test vehicle or the transport-under-test, or, each of the transports/vehicles may be a node in the blockchain, that are connected in a blockchain network.

One feature of the present disclosure relates to sensor self-calibration performed by a test vehicle at multiple locations or in motion via a test vehicle equipped with the calibration devices.

In one example, a method, comprises, determining a location of a test vehicle, determining a location of a test-rig on the test vehicle and determining a location of a calibration device on the test-rig. The method also comprises the calibration device being detectable by one or more sensors on a transport-under-test and transmitting a calibration result. The calibration result comprises the determined location of the test vehicle, the determined location of the test-rig on the test vehicle and the determined location of the calibration device on the test-rig, from the test-rig to at least one of the test vehicle and the transport-under-test.

The calibration results may be received by the calibration device from the one or more sensors i.e. the sensors, from the any device located on the transport, from a server or other device located off the transport, if the calibration results are sent to the server or other device from the sensors.

In this disclosure the term ‘via’ may mean directly by an object such as the sensor, calibration device, etc. or indirectly by an object such as through a server, storage, or other device.

Modern vehicles have a myriad of sensors measuring the location of objects with relation to the vehicle, both stationary and mobile. The location of these objects may be measured by sound, radar, infrared, etc. A stationary measurement of location with relation to the transport-under-test is straightforward, however, a mobile measurement of location of objects where both the transport-under-test and the test vehicle are in motion is more complex and representative of actual driving conditions.

This test vehicle in motion to transport-under-test in motion calibration is the focus of one example in the disclosure. The increased complexity of dual movement of the test vehicle and the transport-under-test mitigates toward a more concrete approach to sensor calibration of the transport-under-test as errors in feedback may have dire results while driving.

In one example, the calibration device has well-defined sensor detection characteristics. In one example, the calibration device is a reflector, wherein the reflection characteristics are well defined so that a signal detected by a sensor may be resolved with little error. The calibration device may be passive such as an optical reflector, an infrared reflector, an RF reflector and the like. The calibration device may also be active such as a thermal emitter such as an infrared emitter, an RF emitter, an optical emitter, an optical image, an RF image, an infrared image and the like. The calibration device is a device on the test vehicle viewable by the sensor on the transport-under-test, such that the sensor outputs a sensor signal when detecting the calibration device. This detected sensor signal along with information pertaining to the calibration device and the relative positions of the test vehicle and the transport-under-test may be used to determine an error in the detected signal and if outside of an acceptable error band, used for the calibration of the sensor.

In one example the test-rig may have several features, an attachment feature, a communication feature and a position feedback feature.

In one embodiment, the test-rig may be attached to the outer surface of the test vehicle. The test-rig attachment may be by magnets, rail connections, connections to the window surfaces, connection to the license plates, rotating connection to the wheel and the like. The test-rig may be anywhere on the vehicle, integrated within the vehicle, outside the vehicle, or proximate to the vehicle. The test-rig is a device that retains a calibration device.

Communication from the test-rig may be sent wirelessly, from a sensor connection pad, a sensor connection pin, and the like. The communication from the test-rig indicates at least information pertaining to the location of the test vehicle and may further indicate information pertaining to the calibration device, type, location and number, the test-rig location on the vehicle, within the vehicle, proximate the vehicle, etc. The communication from the test-rig is termed a calibration result. The data set may include additional information such as reflectivity of the calibration device, angle of the calibration device is pitch, roll and yaw compared to the centerline of the test vehicle, movement of the calibration device with respect to the test vehicle, an RF signature, thermal signature or the like of the calibration device.

In one embodiment, the test-rig attachment may have a feedback device that indicates the location of the test-rig on the vehicle, such as a resistive strip, an attachment peg, a sensor connection pad, a sensor connection pin, a wireless location feedback and the like. The test-rig may be pre-programmed with the location of the calibration device on the test-rig and the location of the test-rig on the test vehicle. This calibration device relative position on the test vehicle may be sent in the calibration result from the test vehicle to the transport-under-test to allow the transport-under-test to determine the exact location of the calibration device on the test vehicle as well as the exact location of the test vehicle with respect to the transport-under-test.

The term test-rig is utilized when the calibration device is associated with the test vehicle. When the calibration device is associated with the transport-under-test, the rig holding the calibration device is termed a calibration-rig for purposes of this disclosure.

The test rig transmits the calibration data, which is received by the transport-under-test. When the test vehicle and the transport-under-test are within a predefined proximity the data pertaining to the location of the calibration device and its characteristics are received by the transport-under-test and a series of determinations are made. This series of determinations include, based on the calibration data and the transport-under-test, the actual distance between the test vehicle and the transport-under-test, the perceived distance by the sensor of the test vehicle and the delta between the two, termed the calibration error. If the calibration error exceeds a predetermined threshold, the sensor is recalibrated.

FIG. 1B illustrates an example system 150, comprising a test vehicle 110 including a calibration device 114 coupled to a test rig 120 and a transport-under-test 112 including one or more sensors 122. A proximity detector is electrically coupled with the transport-under-test that determines when the test vehicle in motion is proximate to the transport-under-test in motion. The proximity detector may include a test vehicle spatial location sensor 128 and a transport-under-test spatial location sensor 130, a radar, a sonar an optical sensor and the like. A transmitter 124 is responsive to the calibration device 114, that transmits a calibration result to the one or more sensors 122 and a receiver 126 responsive to the one or more sensors, that receives the calibration result, via the calibration device. The test vehicle determines an error with the one or more sensors based on the calibration result and the transport-under-test calibrates the one or more sensors based on the error.

The transmitter transmits a calibration result that comprising the determined location of the test vehicle, the determined location of the test-rig on the test vehicle and the determined location of the calibration device on the test-rig, from the test-rig to the test vehicle. The spatial location sensor may be a GPS, a camera, a LIDAR, radar and the like. The test-rig may include a corresponding communications device, such as connectivity pads, located thereon that contact the pins of the mounting rails when the test-rig is coupled to the test vehicle. The coupling may be an electrical feedback either analog or digital indicating a position of the calibration device on the test-rig, such as a resistive feedback, digital location indicator, and the like. The calibration device may be passive as in a reflector or image, or may be active such as a radar ping, illuminated display, sonar ping, and the like. The calibration result may include locations, speeds, headings, relative locations, relative speeds and relative headings of the test vehicle and or the transport-under-test.

The predetermined distance threshold may be set internally by an Electronic Control Unit (ECU), based on the sensor type. When the predetermined distance threshold is met, a proximity signal is sent to the ECU informing it of the proximity of the test-vehicle to the transport-under-test and self-calibration of the sensors initiates.

Another example system comprises, a test-rig registration coupled to a test vehicle, wherein the registration coupling determines a location of the test-rig on the test vehicle and a calibration device is coupled to the test-rig. The coupling determines a location of the calibration device on the test-rig. A test vehicle spatial location sensor is associated with the test vehicle to determine a location of the test vehicle and a transmitter coupled to the test-rig. A receiver connected to a transport-under-test that receives the calibration result from the test vehicle and a transport-under-test spatial location sensor associated with the transport-under-test that determines a location of the transport-under-test. The system also includes a transport-under-test processor associated with the transport-under-test that determines a distance between the test vehicle and the transport-under-test and one or more sensors on the transport-under-test that self-calibrates when the test vehicle is within a predetermined distance threshold to the transport-under-test.

In another example, a non-transitory computer readable medium comprising instructions, that when read by a processor, cause the processor to perform, determining a test vehicle in motion is proximate to a transport-under-test in motion, wherein the test vehicle includes a calibration device, and the transport-under-test includes one or more sensors. The processor further performs transmitting a calibration result from the calibration device to the one or more sensors and receiving the calibration result, via the calibration device, from the one or more sensors. The processor further performs determining, via the test vehicle, an error with the one or more sensors based on the calibration result and calibrating, via the transport-under-test, the one or more sensors based on the error.

In yet another example, a non-transitory computer readable medium comprising instructions, that when read by a processor, cause the processor to perform, determining a location of a test vehicle, determining a location of a test-rig on the test vehicle and determining a location of a calibration device on the test-rig. The calibration device is detectable by one or more sensors on a transport-under-test and transmits a calibration result. The calibration result comprises the determined location of the test vehicle, the determined location of the test-rig on the test vehicle and the determined location of the calibration device on the test-rig, from the test-rig to the test vehicle.

FIG. 1C illustrates sensor calibration 170 via test equipment at mobile locations and fixed locations.

In the example where the test equipment is at mobile locations, the embodiment provides a system capable of performing self-calibration of one or more sensors via sensor test equipment at mobile locations, such as on mobile devices or wearable devices on individuals. The devices are equipped with the calibration software.

In one embodiment, different devices such as mobile phones, watches, wearables and the like, are equipped with calibration software. These devices are mobile in nature as they are associated with individual. Individuals may be walking, riding a scooter/bike, jogging, etc. As the individual is in proximity to transport-under-test, the software on the device tests the transport-under-test and provides results to a server in the cloud, for example.

This may provide additional testing situations, such as various points of view at crosswalks, for example, which may be difficult to obtain in a traditional manner.

In one example, a method comprises, determining a mobile location and mobile position of a calibration device detectable by one or more sensors on a transport-under-test 112, determining a location of the transport-under-test and transmitting a calibration result comprising the determined mobile location and mobile position of the calibration device 118 to at least one of the test vehicle and the transport-under-test.

In another example, a system, comprises, a calibration device at a mobile location and mobile position detectable by one or more sensors on a transport-under-test, a spatial location sensor 130 associated with the transport-under-test to determine a location of the transport-under-test and a transmitter associated with the transport-under-test to transmit a calibration result comprising the mobile location and mobile position of the calibration device to at least one of the test vehicle and the transport-under-test.

The calibration data from the fixed calibration device 116 or the mobile calibration device 118 and the transport-under-test 112 is sent to a server where the calibration data is stored in a blockchain. The transport-under-test may be monitored via one or more sensors that report sensed data to a central controller computer device in the transport-under-test, which in turn, is forwarded to a blockchain and/or a management server for review and action. Additionally, the blockchain may be in a server outside of the transport-under-test which may be a node in the blockchain, that is connected in a blockchain network.

In yet another example, a non-transitory computer readable medium comprises instructions, that when read by a processor, cause the processor to perform, determining a mobile location and mobile position of a calibration device detectable by one or more sensors on a transport-under-test, determining a location of the transport-under-test and transmitting a calibration result comprising the determined mobile location and mobile position of the calibration device to at least one of the test vehicle and the transport-under-test.

In the example where the test equipment is at fixed locations, the embodiment provides a system capable of performing self-calibration of one or more sensors via sensor test equipment at fixed locations, such as at intersections. This allows sensors to be tested when the transport-under-test are on the road, and at various points during the transport-under-test's lifetime.

In one embodiment, sensor test equipment is placed at fixed locations at various heights and locations. Transport-under-test may be aware of various locations and interact with the test equipment accordingly.

For example, as a transport-under-test is traversing an intersection, the equipment at fixed locations at the intersection tests various sensors on the transport-under-test. The testing equipment may contain software of the current invention. The test equipment may be placed at various heights and locations and test multiple scenarios such as different times of day and different weather conditions. There are determined threshold ranges. As transports-under-test goes through intersections, calibration data provided are served to a server in the cloud (for example). The transport-under-test and/or server in the cloud may respond with test results. In another embodiment, only receiving calibration data pertaining is sent that indicates sensors are faulty.

One feature of the embodiment relates to sensor self-calibration systems performed by test equipment on fixed locations such that sensors on transports-under-test may be tested over the lifetime of the transport, in different climactic conditions and different times of day.

In one example embodiment, a method, comprising, determining a fixed location and fixed position of a calibration device detectable by one or more sensors on a transport-under-test 112, determining a location of the transport-under-test and transmitting a calibration result comprising the determined fixed location and fixed position of the calibration device 116 to the transport-under-test.

In another one example embodiment, a system, comprising, a calibration device at a fixed location and fixed position detectable by one or more sensors on a transport-under-test, a spatial location sensor 130 associated with the transport-under-test to determine a location of the transport-under-test and a transmitter associated with the transport-under-test to transmit a calibration result comprising the fixed location and fixed position of the calibration device to the transport-under-test.

In yet another example embodiment, a non-transitory computer readable medium comprising instructions, that when read by a processor, cause the processor to perform, determining a fixed location and fixed position of a calibration device detectable by one or more sensors on a transport-under-test, determining a location of the transport-under-test and transmitting a calibration result comprising the determined fixed location and fixed position of the calibration device to the transport-under-test.

FIG. 1D illustrates sensor calibration 180 via a calibration-rig and calibration device mounted directly on the transport-under-test. FIG. 1E illustrates the electrical connection and communication device of the calibration-rig and calibration device mounted on the transport-under-test.

In one embodiment, the calibration-rig 132 may be coupled to the transport-under-test 112 directly. This embodiment of the present disclosure provides that calibration devices 114 are mounted on a calibration-rig 132 that is fixed to a transport-under-test wherein the various sensors on the transport are able to automatically self-adjust based on what should be detected by the calibration devices as compared to what is actually detected.

The embodiment provides calibration devices on a transport-under-test 112 either fixed on the transport-under-test or supported in a temporary fashion by the transport-under-test. The calibration-rig contains communication elements 140 such that calibration data is sent from the calibration devices to a transport-under-test computer. The calibration data reflects details of the calibration devices, and this calibration data is compared against sensor data from sensors that are being tested. When the sensor is not within an acceptable error margin, self-calibration functionality allows the sensors to automatically self-adjust.

The purpose of the embodiment is to provide sensor self-calibration systems for a transport-under-test via one or more mounting points located along an exterior body of the transport, the mounting points having components therein that receive and transmit data with a calibration object coupled thereto.

The embodiment provides a system capable of performing self-calibration of one or more sensors positioned thereon by configuring the transport-under-test to be communicatively coupled with calibration equipment without requiring use of the warehouse facility.

FIGS. 1D and 1E illustrate an example embodiment that includes a transport-under-test body that includes one or more mounting points 142 and/or devices positioned along an exterior surface of the transport-under-test. In one embodiment, the transport-under-test includes a pair of mounting rails 136 positioned along a roof surface of the transport-under-test 112 such as a roof rack and the like.

The mounting rails may include a communications device 140 disposed therein, where the device is configured to facilitate sensor self-calibration. Specifically, the communications device in the mounting rail may include connection pins 142 therein, such as pogo pins or the like, that are configured to interact with a calibration-rig 132 that is received on the roof of the transport-under-test and coupled to the mounting rails through a connectivity pad 138.

The calibration-rig 132 may include a corresponding communications device 140, such as connectivity pads 138, located thereon that contact the connection pins 142 of the mounting rails 136 when the calibration-rig is coupled thereto. The calibration-rig may communicate calibration data, to the transport-under-test's electronic control unit via the connection of the pads and pins. In other embodiments, the calibration-rig may wirelessly communicate calibration information to the electronic control unit (ECU).

As shown in FIG. 1D, in one example, the calibration-rig 132 may include an outwardly extending arm 134 that includes a calibration device 114 such as a lateral pad coupled to a terminal end of the arm. With the calibration-rig attached to a roof of the transport-under-test at the mounting rails, the arm of the rig effectively extends toward a front end of the transport-under-test such that the pad is positioned ahead of the transport-under-test.

One or more sensors 122 and/or system devices of the transport-under-test may detect the pad and perform self-calibration based on the calibration information provided by the calibration-rig to the transport-under-test's ECU, and calibration data detected by the sensor itself in response to identifying the pad.

For instance, a sensor such as a camera that is positioned on a front bumper of the transport-under-test may detect the pad and determine a relative location of the pad from the front bumper of the transport-under-test for communication to the ECU. The calibration-rig, knowing a geometry, size, and position of the arm and pad extending outwardly therefrom, communicates this location data, i.e. calibration data of the pad to the ECU. With the ECU receiving both sources of data the transport-under-test is capable of performing a self-calibration of the camera device.

One feature of the embodiment relates to sensor self-calibration systems positioned within the transport-under-test such as in mounting rails located along an exterior roof of the transport-under-test body to receive and transmit location and/or calibration data received from calibration rigs/objects coupled to the transport-under-test thereon.

A transport-under-test may include additional mounting points and/or devices positioned along various exterior surfaces of the transport-under-test body for receiving a calibration-rig thereon. Accordingly, multiple sensors disposed at various locations along a transport-under-test body may detect and identify a location of the calibration-rig attached thereto for conducting self-calibration of the sensor.

In one embodiment the calibration device 114 is mounted within the interior of the transport-under-test 112. The calibration device 114 may be mounted to the transport's dash, steering column, window, or be placed within a seat. The calibration device may be a reflector, electronic transmitter, a person shaped dummy in one of the seats and the like. The calibration device would function in the same way as an external device, in this case, the calibration rig would be secured within the interior of the vehicle. This would allow the calibration device to be subject to the same visibility conditions and visual occlusions as the driver and passengers.

The calibration data from the transport-under-test 112 is sent to a server where the calibration data is stored in a blockchain. The transport-under-test may be monitored via one or more sensors that report sensed data to a central controller computer device in the transport-under-test, which in turn, is forwarded to a blockchain and/or a management server for review and action. Additionally, the blockchain may be in a server outside of the transport-under-test may be a node in the blockchain, that is connected in a blockchain network.

In one example embodiment, a method, comprises, determining a location of a calibration-rig on a transport-under-test, determining a location of a calibration device on the calibration-rig and detecting the calibration device by one or more sensors on the transport-under-test. The method also includes transmitting a calibration result comprising the determined location of the calibration-rig on the transport-under-test and the determined location of the calibration device on the calibration-rig and self-calibrating the sensor based on the calibration result.

In another example embodiment, a system, comprises, a calibration-rig registration coupled to a transport-under-test, wherein the registration coupling determines a location of the calibration-rig on the transport-under-test and a calibration device coupled to the calibration-rig. The coupling determines a location of the calibration device on the calibration-rig, a transmitter coupled to the calibration-rig that transmits a calibration result that comprising the determined location of the calibration-rig on the transport-under-test and the determined location of the calibration device on the calibration-rig and one or more sensors that self-calibrate based on the transmitted calibration result.

In yet another example embodiment, a non-transitory computer readable medium comprising instructions, that when read by a processor, causes the processor to perform, determining a location of a calibration-rig on a transport-under-test, determining a location of a calibration device on the calibration-rig and detecting the calibration device by one or more sensors on the transport-under-test. The processor also performs transmitting a calibration result comprising the determined location of the calibration-rig on the transport-under-test and the determined location of the calibration device on the calibration-rig and self-calibrating the sensor based on the calibration result.

The calibration-rig may have one or more devices mounted on them such as reflectors, a camera calibration image and a reflector, and the like. There are numerous mounting points available on a transport-under-test.

The mounting points may be temporary or permanent, for example, a reflector may be placed in the side-view mirror and radar which can see the reflector can use it for calibration.

In one example method, the calibration rig may be mounted and communicate with a transport-under-test the location of its calibration points, types, shapes, sizes and the like. If the sensor detects discrepancies between communicated information and sensed information it may adjust internal parameters, correct its physical location, or report an unable to self-correct error.

Multiple levels of armature complexity may be encompassed by the embodiments such as, mounted with a static bracket or equipped on a vehicle, a static arm in horizontal and/or lateral position from the calibration-rig, a motorized movable arm, or a robotic arm capable of complex maneuvers. The level of complexity would depend of positioning or movement requirements of a given sensor for calibration.

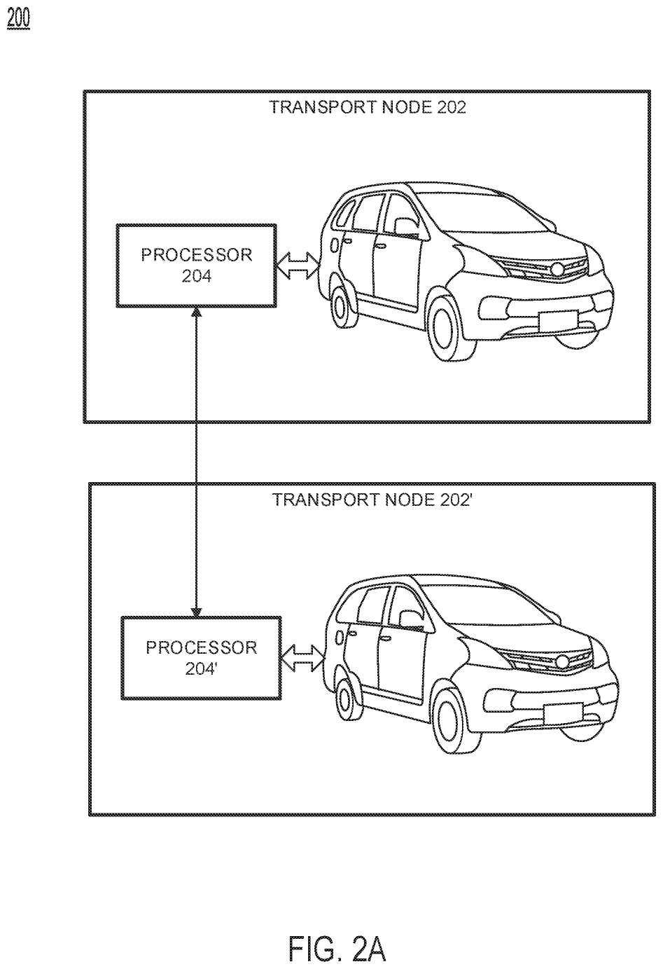

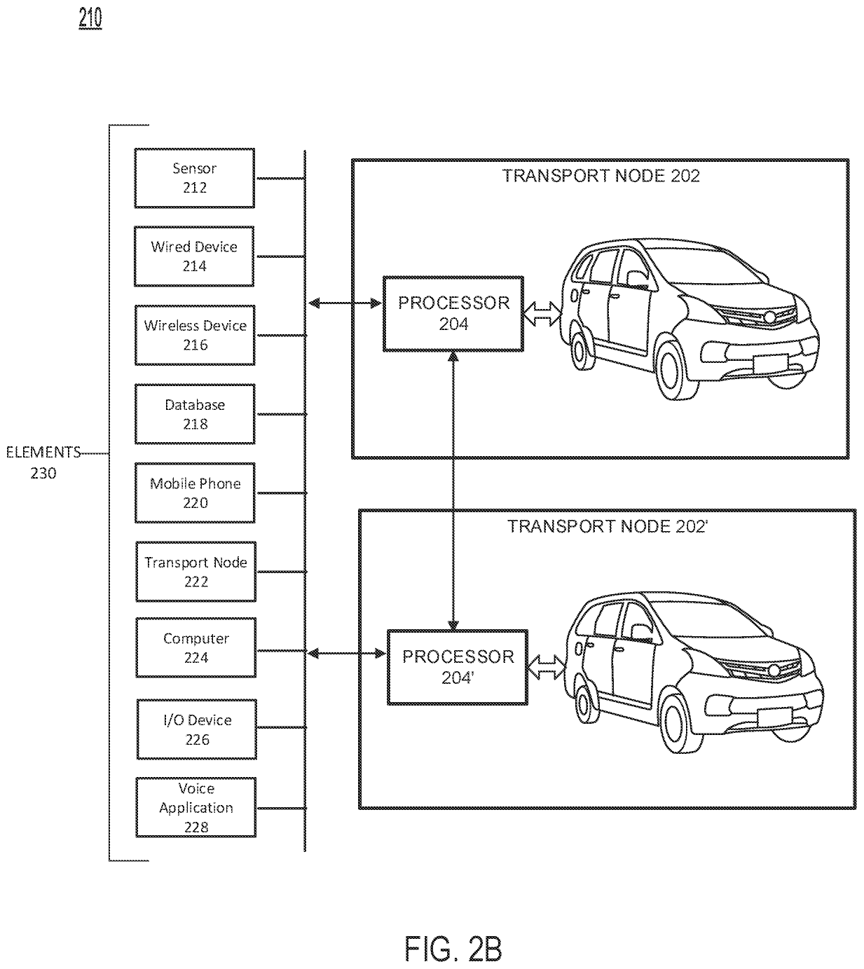

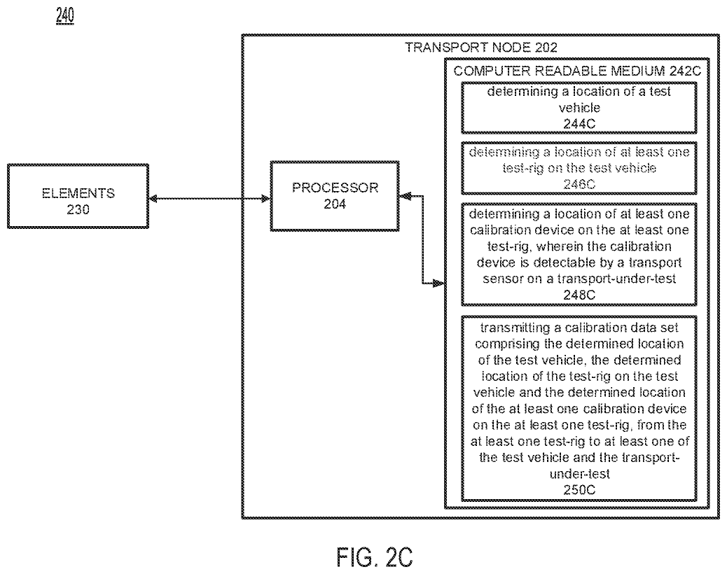

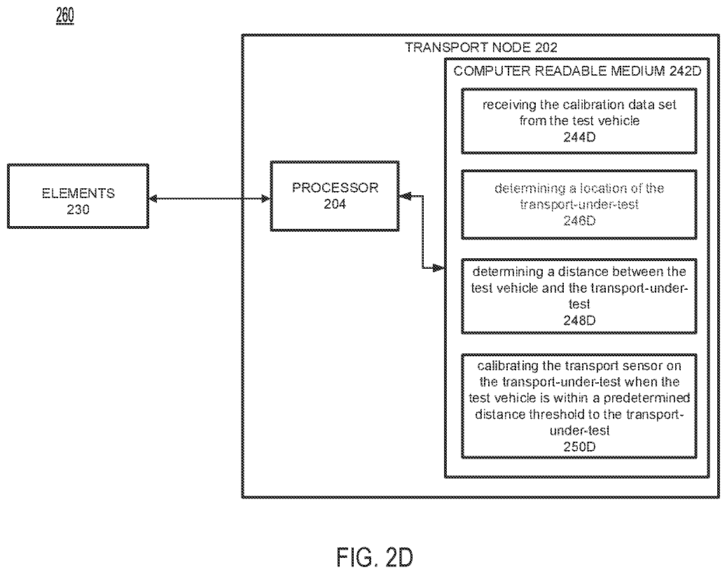

FIG. 2A illustrates a transport network diagram 200, according to example embodiments. The network comprises elements including a transport node 202 including a processor 204, as well as a transport node 202′ including a processor 204′. The transport nodes 202, 202′ communicate with one another via the processors 204, 204′, as well as other elements (not shown) including transceivers, transmitters, receivers, storage, sensors and other elements capable of providing communication. The communication between the transport nodes 202, 202′ can occur directly, via a private and/or a public network (not shown) or via other transport nodes and elements comprising one or more of a processor, memory, and software. Although depicted as single transport nodes and processors, a plurality of transport nodes and processors may be present. One or more of the applications, features, steps, solutions, etc., described and/or depicted herein may be utilized and/or provided by the instant elements.

FIG. 2B illustrates another transport network diagram 210, according to example embodiments. The network comprises elements including a transport node 202 including a processor 204, as well as a transport node 202′ including a processor 204′. The transport nodes 202, 202′ communicate with one another via the processors 204, 204′, as well as other elements (not shown) including transceivers, transmitters, receivers, storage, sensors and other elements capable of providing communication. The communication between the transport nodes 202, 202′ can occur directly, via a private and/or a public network (not shown) or via other transport nodes and elements comprising one or more of a processor, memory, and software. The processors 204, 204′ can further communicate with one or more elements 230 including sensor 212, wired device 214, wireless device 216, database 218, mobile phone 220, transport node 222, computer 224, I/O device 226 and voice application 228. The processors 204, 204′ can further communicate with elements comprising one or more of a processor, memory, and software.

Although depicted as single transport nodes, processors and elements, a plurality of transport nodes, processors and elements may be present. Information or communication can occur to and/or from any of the processors 204, 204′ and elements 230. For example, the mobile phone 220 may provide information to the processor 204 which may initiate the transport node 202 to take an action, may further provide the information or additional information to the processor 204′ which may initiate the transport node 202′ to take an action, may further provide the information or additional information to the mobile phone 220, the transport node 222, and/or the computer 224. One or more of the applications, features, steps, solutions, etc., described and/or depicted herein may be utilized and/or provided by the instant elements.

FIG. 2C illustrates yet another transport network diagram 240, according to example embodiments. The network comprises elements including a transport node 202 including a processor 204 and a non-transitory computer readable medium 242C. The processor 204 is communicably coupled to the non-transitory computer readable medium 242C and elements 230 (which were depicted in FIG. 2B).

The processor 204 performs one or more of determining 244C a location of a test vehicle, determining 246C a location of a test-rig on the test vehicle and determining 248C a location of a calibration device on the test-rig. The calibration device is detectable by one or more sensors on a transport-under-test. The flow also comprises transmitting 250C a calibration result comprising the determined location of the test vehicle, the determined location of the test-rig on the test vehicle and the determined location of the calibration device on the test-rig, from the test-rig to at least one of the test vehicle and the transport-under-test.

FIG. 2D illustrates a further transport network diagram 260, according to example embodiments. The network comprises elements including a transport node 202 including a processor 204 and a non-transitory computer readable medium 242D. The processor 204 is communicably coupled to the non-transitory computer readable medium 242D and elements 230 (which were depicted in FIG. 2B).

The processor 204 performs one or more of receiving 244D the calibration result from the test vehicle, determining 246D a location of the transport-under-test, determining 248D a distance between the test vehicle and the transport-under-test and calibrating 250D the sensor on the transport-under-test when the test vehicle is within a predetermined distance threshold to the transport-under-test.

The processors and/or computer readable media may fully or partially reside in the interior or exterior of the transport nodes. The steps or features stored in the computer readable media may be fully or partially performed by any of the processors and/or elements in any order. Additionally, one or more steps or features may be added, omitted, combined, performed at a later time, etc.

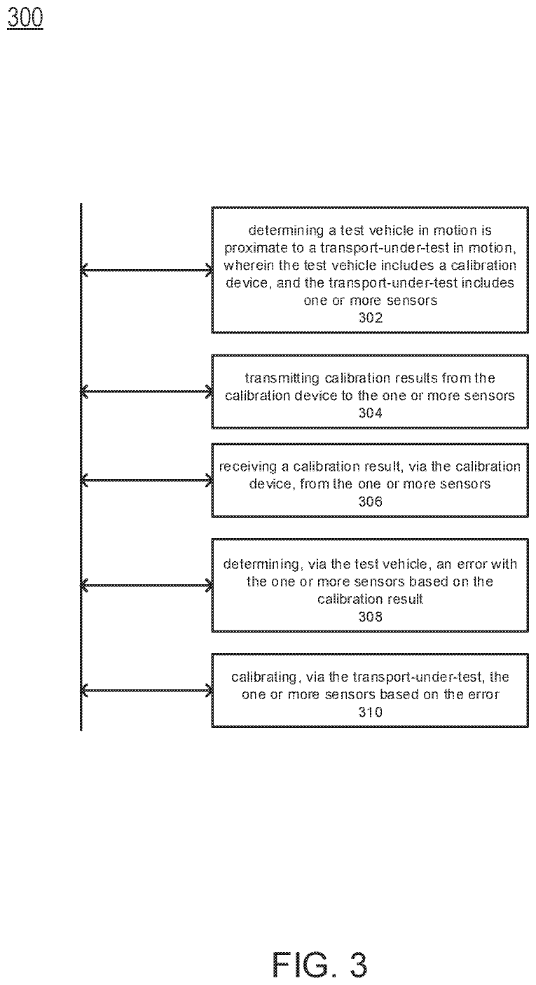

FIG. 3 illustrates a flow diagram 300, according to example embodiments. Referring to FIG. 3, the flow comprises determining 302 a test vehicle in motion is proximate to a transport-under-test in motion, wherein the test vehicle includes a calibration device, and the transport-under-test includes one or more sensors. The flow further includes transmitting 304 calibration results from the calibration device to the one or more sensors and receiving 306 a calibration result, via the calibration device, from the one or more sensors. The flow also includes determining 308, via the test vehicle, an error with the one or more sensors based on the calibration result and calibrating 310, via the transport-under-test, the one or more sensors based on the error.

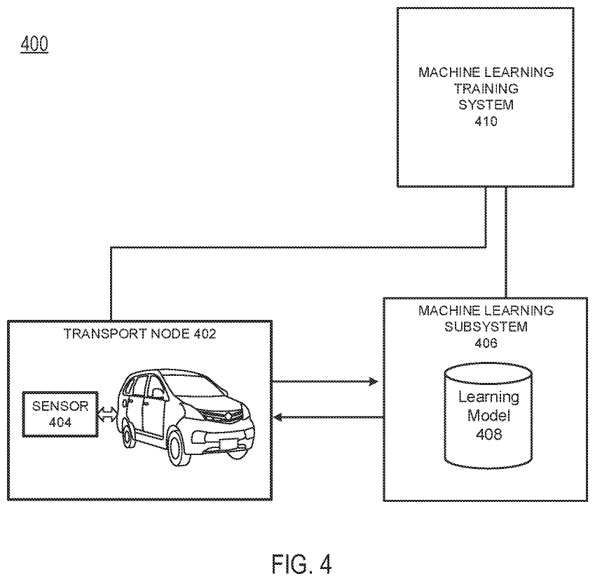

FIG. 4 illustrates a machine learning transport network diagram 400, according to example embodiments. The network 400 includes a transport node 402 that interfaces with a machine learning subsystem 406. The transport node includes one or more sensors 404.

The machine learning subsystem 406 contains a learning model 408 which is a mathematical artifact created by a machine learning training system 410 that generates predictions by finding patterns in one or more training data sets. In some embodiments, the machine learning subsystem 406 resides in the transport node 402. In other embodiments, the machine learning subsystem 406 resides outside of the transport node 402.

The transport node 402 sends data from the one or more sensors 404 to the machine learning subsystem 406. The machine learning subsystem 406 provides the one or more sensor 404 data to the learning model 408 which returns one or more predictions. The machine learning subsystem 406 sends one or more instructions to the transport node 402 based on the predictions from the learning model 408.

In a further embodiment, the transport node 402 may send the one or more sensor 404 data to the machine learning training system 410. In yet another embodiment, the machine learning subsystem 406 may sent the sensor 404 data to the machine learning subsystem 410. One or more of the applications, features, steps, solutions, etc., described and/or depicted herein may utilize the machine learning network 400 as described herein.

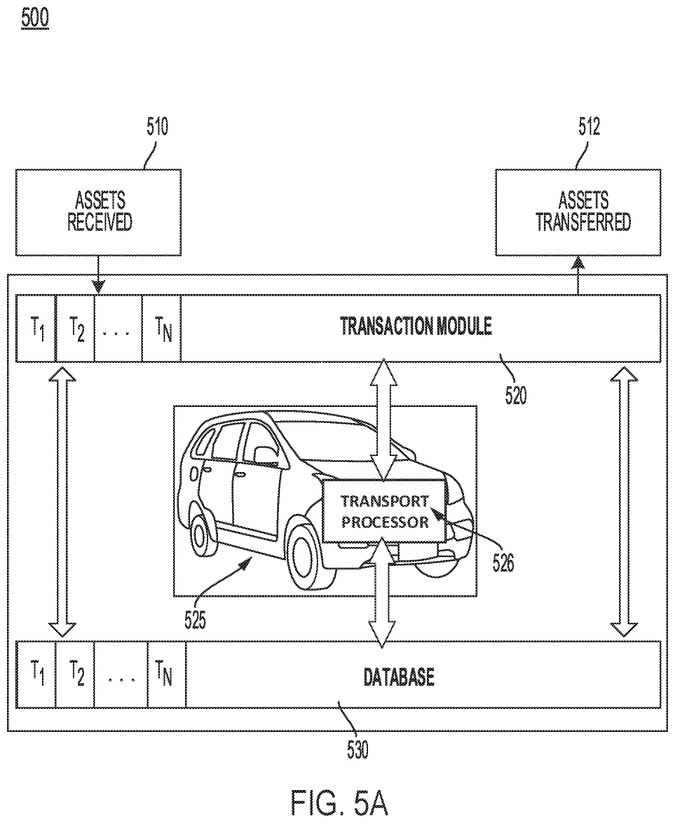

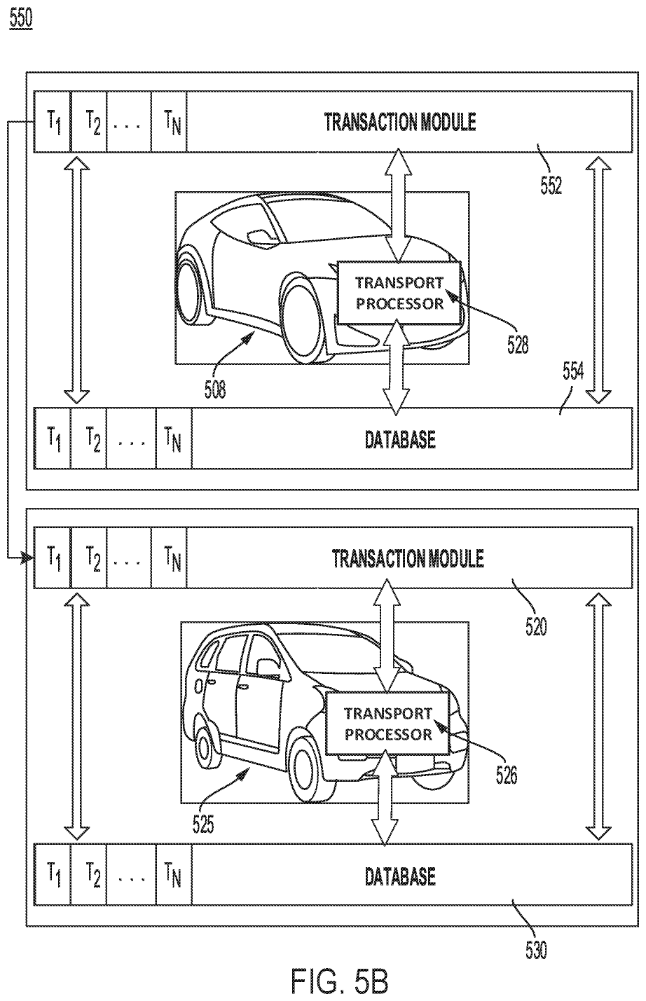

FIG. 5A illustrates an example vehicle configuration 500 for managing database transactions associated with a vehicle, according to example embodiments. Referring to FIG. 5A, as a particular transport/vehicle 525 is engaged in transactions (e.g., vehicle service, dealer transactions, delivery/pickup, transportation services, etc.), the vehicle may receive assets 510 and/or expel/transfer assets 512 according to a transaction(s). A transport processor 526 resides in the vehicle 525 and communication exists between the transport processor 526, a database 530, a transport processor 526 and the transaction module 520. The transaction module 520 may record information, such as assets, parties, credits, service descriptions, date, time, location, results, notifications, unexpected events, etc. Those transactions in the transaction module 520 may be replicated into a database 530. The database 530 can be one of a SQL database, an RDBMS, a relational database, a non-relational database, a blockchain, a distributed ledger, and may be on board the transport, may be off board the transport, may be accessible directly and/or through a network, or be accessible to the transport.

FIG. 5B illustrates an example vehicle configuration 550 for managing database transactions conducted among various vehicles, according to example embodiments. The vehicle 525 may engage with another vehicle 508 to perform various actions such as to share, transfer, acquire service calls, etc. when the vehicle has reached a status where the services need to be shared with another vehicle. For example, the vehicle 508 may be due for a battery charge and/or may have an issue with a tire and may be in route to pick up a package for delivery. A transport processor 528 resides in the vehicle 508 and communication exists between the transport processor 528, a database 554, a transport processor 528 and the transaction module 552. The vehicle 508 may notify another vehicle 525 which is in its network and which operates on its blockchain member service. A transport processor 526 resides in the vehicle 525 and communication exists between the transport processor 526, a database 530, the transport processor 526 and a transaction module 520. The vehicle 525 may then receive the information via a wireless communication request to perform the package pickup from the vehicle 508 and/or from a server (not shown). The transactions are logged in the transaction modules 552 and 520 of both vehicles. The credits are transferred from vehicle 508 to vehicle 525 and the record of the transferred service is logged in the database 530/554 assuming that the blockchains are different from one another, or, are logged in the same blockchain used by all members. The database 554 can be one of a SQL database, an RDBMS, a relational database, a non-relational database, a blockchain, a distributed ledger, and may be on board the transport, may be off board the transport, may be accessible directly and/or through a network.

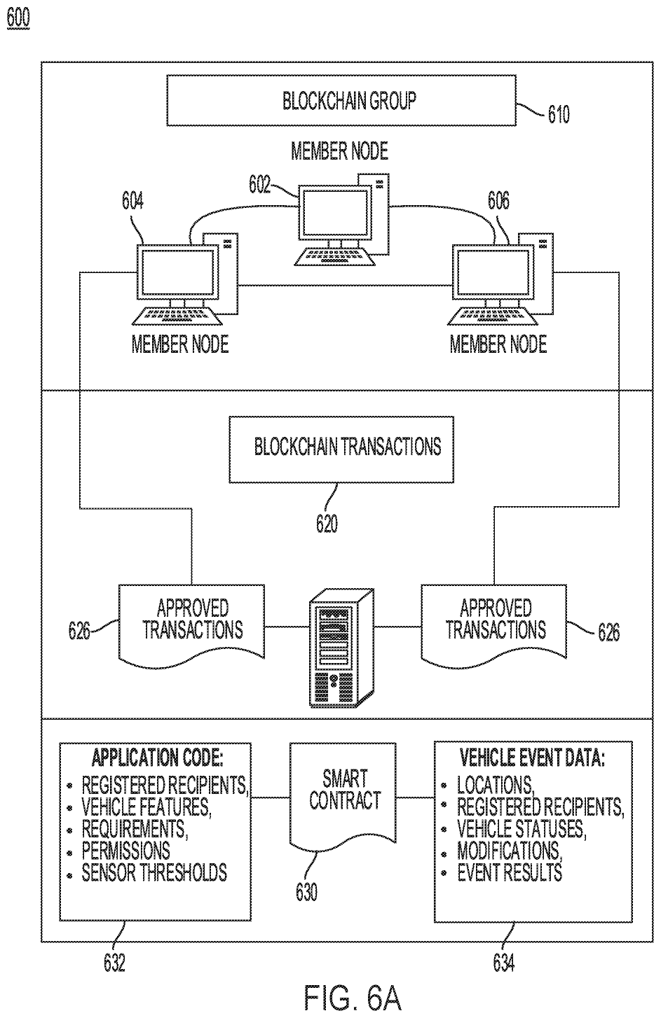

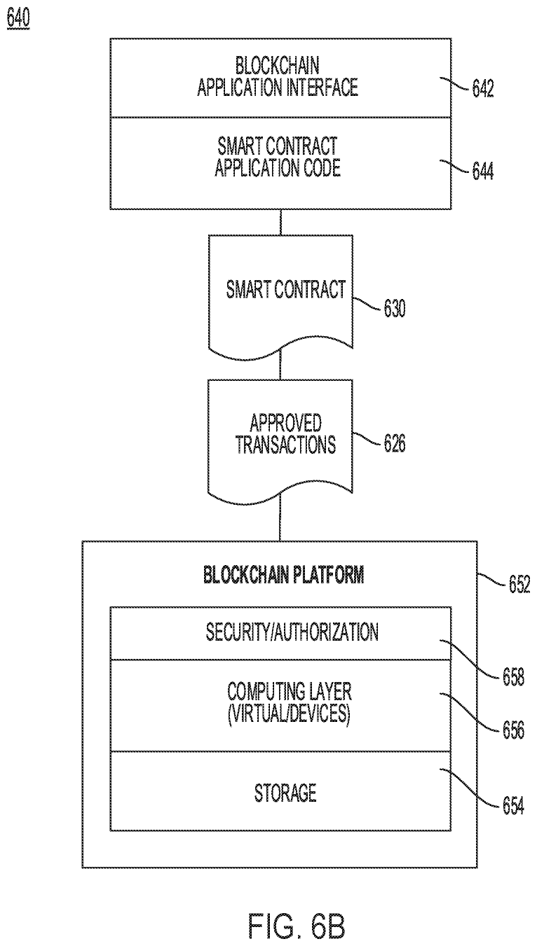

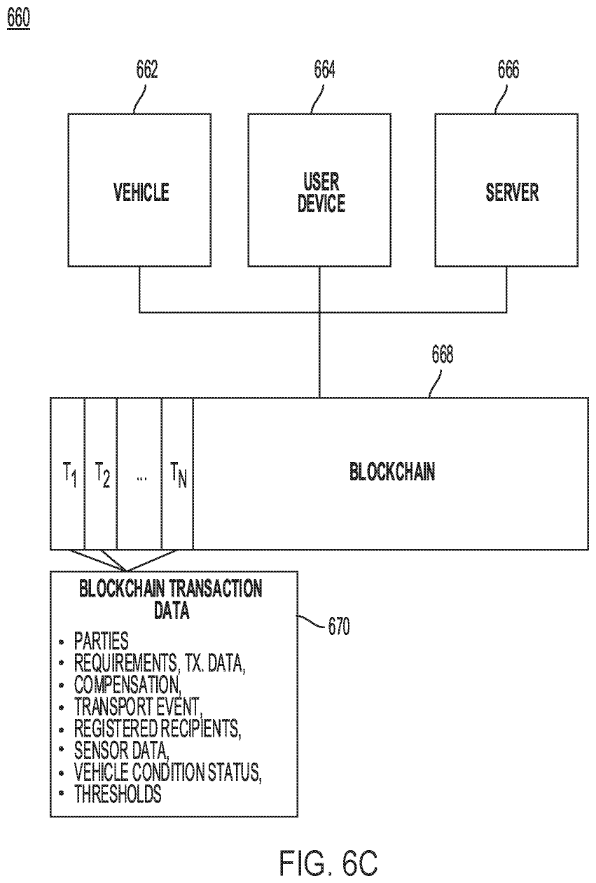

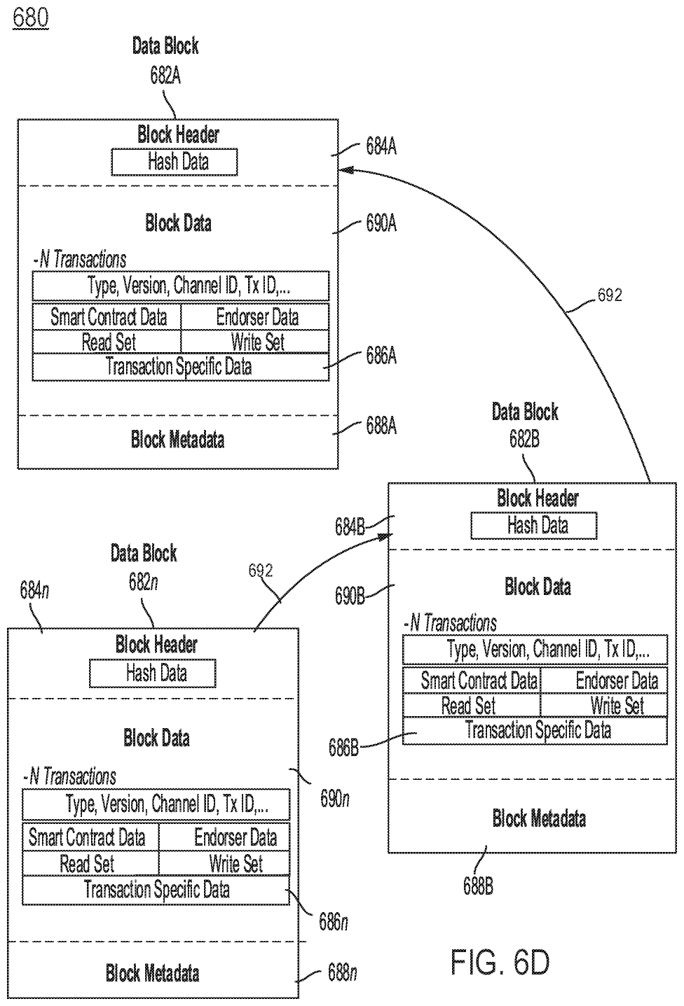

FIG. 6A illustrates a blockchain architecture configuration 600, according to example embodiments. Referring to FIG. 6A, the blockchain architecture 600 may include certain blockchain elements, for example, a group of blockchain member nodes 602-606 as part of a blockchain group 610. In one example embodiment, a permissioned blockchain is not accessible to all parties but only to those members with permissioned access to the blockchain data. The blockchain nodes participate in a number of activities, such as blockchain entry addition and validation process (consensus). One or more of the blockchain nodes may endorse entries based on an endorsement policy and may provide an ordering service for all blockchain nodes. A blockchain node may initiate a blockchain action (such as an authentication) and seek to write to a blockchain immutable ledger stored in the blockchain, a copy of which may also be stored on the underpinning physical infrastructure.

The blockchain transactions 620 are stored in memory of computers as the transactions are received and approved by the consensus model dictated by the members' nodes. Approved transactions 626 are stored in current blocks of the blockchain and committed to the blockchain via a committal procedure which includes performing a hash of the data contents of the transactions in a current block and referencing a previous hash of a previous block. Within the blockchain, one or more smart contracts 630 may exist that define the terms of transaction agreements and actions included in smart contract executable application code 632, such as registered recipients, vehicle features, requirements, permissions, sensor thresholds, etc. The code may be configured to identify whether requesting entities are registered to receive vehicle services, what service features they are entitled/required to receive given their profile statuses and whether to monitor their actions in subsequent events. For example, when a service event occurs and a user is riding in the vehicle, the sensor data monitoring may be triggered, and a certain parameter, such as a vehicle charge level, may be identified as being above/below a particular threshold for a particular period of time, then the result may be a change to a current status which requires an alert to be sent to the managing party (i.e., vehicle owner, vehicle operator, server, etc.) so the service can be identified and stored for reference. The vehicle sensor data collected may be based on types of sensor data used to collect information about vehicle's status. The sensor data may also be the basis for the vehicle event data 634, such as a location(s) to be traveled, an average speed, a top speed, acceleration rates, whether there were any collisions, was the expected route taken, what is the next destination, whether safety measures are in place, whether the vehicle has enough charge/fuel, etc. All such information may be the basis of smart contract terms 630, which are then stored in a blockchain. For example, sensor thresholds stored in the smart contract can be used as the basis for whether a detected service is necessary and when and where the service should be performed.

FIG. 6B illustrates a shared ledger configuration, according to example embodiments. Referring to FIG. 6B, the blockchain logic example 640 includes a blockchain application interface 642 as an application programming interface or plug-in application that links to the computing device and execution platform for a particular transaction. The blockchain configuration 640 may include one or more applications which are linked to application programming interfaces (APIs) to access and execute stored program/application code (e.g., smart contract executable code, smart contracts, etc.) which can be created according to a customized configuration sought by participants and can maintain their own state, control their own assets, and receive external information. This can be deployed as an entry and installed, via appending to the distributed ledger, on all blockchain nodes.

The smart contract application code 644 provides a basis for the blockchain transactions by establishing application code which when executed causes the transaction terms and conditions to become active. The smart contract 630, when executed, causes certain approved transactions 626 to be generated, which are then forwarded to the blockchain platform 652. The platform includes a security/authorization 658, computing devices which execute the transaction management 656 and a storage portion 654 as a memory that stores transactions and smart contracts in the blockchain.

The blockchain platform may include various layers of blockchain data, services (e.g., cryptographic trust services, virtual execution environment, etc.), and underpinning physical computer infrastructure that may be used to receive and store new entries and provide access to auditors which are seeking to access data entries. The blockchain may expose an interface that provides access to the virtual execution environment necessary to process the program code and engage the physical infrastructure. Cryptographic trust services may be used to verify entries such as asset exchange entries and keep information private.

The blockchain architecture configuration of FIGS. 6A and 6B may process and execute program/application code via one or more interfaces exposed, and services provided, by the blockchain platform. As a non-limiting example, smart contracts may be created to execute reminders, updates, and/or other notifications subject to the changes, updates, etc. The smart contracts can themselves be used to identify rules associated with authorization and access requirements and usage of the ledger. For example, the information may include a new entry, which may be processed by one or more processing entities (e.g., processors, virtual machines, etc.) included in the blockchain layer. The result may include a decision to reject or approve the new entry based on the criteria defined in the smart contract and/or a consensus of the peers. The physical infrastructure may be utilized to retrieve any of the data or information described herein.

Within smart contract executable code, a smart contract may be created via a high-level application and programming language, and then written to a block in the blockchain. The smart contract may include executable code which is registered, stored, and/or replicated with a blockchain (e.g., distributed network of blockchain peers). An entry is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A smart contract executable code may include the code interpretation of a smart contract, with additional features. As described herein, the smart contract executable code may be program code deployed on a computing network, where it is executed and validated by chain validators together during a consensus process. The smart contract executable code receives a hash and retrieves from the blockchain a hash associated with the data template created by use of a previously stored feature extractor. If the hashes of the hash identifier and the hash created from the stored identifier template data match, then the smart contract executable code sends an authorization key to the requested service. The smart contract executable code may write to the blockchain data associated with the cryptographic details.

FIG. 6C illustrates a blockchain configuration for storing blockchain transaction data, according to example embodiments. Referring to FIG. 6C, the example configuration 660 provides for the vehicle 662, the user device 664 and a server 666 sharing information with a distributed ledger (i.e., blockchain) 668. The server may represent a service provider entity inquiring with a vehicle service provider to share user profile rating information in the event that a known and established user profile is attempting to rent a vehicle with an established rated profile. The server 666 may be receiving and processing data related to a vehicle's service requirements. As the service events occur, such as the vehicle sensor data indicates a need for fuel/charge, a maintenance service, etc., a smart contract may be used to invoke rules, thresholds, sensor information gathering, etc., which may be used to invoke the vehicle service event. The blockchain transaction data 670 is saved for each transaction, such as the access event, the subsequent updates to a vehicle's service status, event updates, etc. The transactions may include the parties, the requirements (e.g., 18 years of age, service eligible candidate, valid driver's license, etc.), compensation levels, the distance traveled during the event, the registered recipients permitted to access the event and host a vehicle service, rights/permissions, sensor data retrieved during the vehicle event operation to log details of the next service event and identify a vehicle's condition status, and thresholds used to make determinations about whether the service event was completed and whether the vehicle's condition status has changed.

FIG. 6D illustrates blockchain blocks 680 that can be added to a distributed ledger, according to example embodiments, and contents of block structures 682A to 682n. Referring to FIG. 6D, clients (not shown) may submit entries to blockchain nodes to enact activity on the blockchain. As an example, clients may be applications that act on behalf of a requester, such as a device, person or entity to propose entries for the blockchain. The plurality of blockchain peers (e.g., blockchain nodes) may maintain a state of the blockchain network and a copy of the distributed ledger. Different types of blockchain nodes/peers may be present in the blockchain network including endorsing peers which simulate and endorse entries proposed by clients and committing peers which verify endorsements, validate entries, and commit entries to the distributed ledger. In this example, the blockchain nodes may perform the role of endorser node, committer node, or both.

The instant system includes a blockchain which stores immutable, sequenced records in blocks, and a state database (current world state) maintaining a current state of the blockchain. One distributed ledger may exist per channel and each peer maintains its own copy of the distributed ledger for each channel of which they are a member. The instant blockchain is an entry log, structured as hash-linked blocks where each block contains a sequence of N entries. Blocks may include various components such as those shown in FIG. 6D. The linking of the blocks may be generated by adding a hash of a prior block's header within a block header of a current block. In this way, all entries on the blockchain are sequenced and cryptographically linked together preventing tampering with blockchain data without breaking the hash links. Furthermore, because of the links, the latest block in the blockchain represents every entry that has come before it. The instant blockchain may be stored on a peer file system (local or attached storage), which supports an append-only blockchain workload.

The current state of the blockchain and the distributed ledger may be stored in the state database. Here, the current state data represents the latest values for all keys ever included in the chain entry log of the blockchain. Smart contract executable code invocations execute entries against the current state in the state database. To make these smart contract executable code interactions extremely efficient, the latest values of all keys are stored in the state database. The state database may include an indexed view into the entry log of the blockchain, it can therefore be regenerated from the chain at any time. The state database may automatically get recovered (or generated if needed) upon peer startup, before entries are accepted.

Endorsing nodes receive entries from clients and endorse the entry based on simulated results. Endorsing nodes hold smart contracts which simulate the entry proposals. When an endorsing node endorses an entry, the endorsing nodes creates an entry endorsement which is a signed response from the endorsing node to the client application indicating the endorsement of the simulated entry. The method of endorsing an entry depends on an endorsement policy which may be specified within smart contract executable code. An example of an endorsement policy is “the majority of endorsing peers must endorse the entry.” Different channels may have different endorsement policies. Endorsed entries are forward by the client application to an ordering service.

The ordering service accepts endorsed entries, orders them into a block, and delivers the blocks to the committing peers. For example, the ordering service may initiate a new block when a threshold of entries has been reached, a timer times out, or another condition. In this example, blockchain node is a committing peer that has received a data block 682A for storage on the blockchain. The ordering service may be made up of a cluster of orderers. The ordering service does not process entries, smart contracts, or maintain the shared ledger. Rather, the ordering service may accept the endorsed entries and specifies the order in which those entries are committed to the distributed ledger. The architecture of the blockchain network may be designed such that the specific implementation of ‘ordering’ (e.g., Solo, Kafka, BFT, etc.) becomes a pluggable component.

Entries are written to the distributed ledger in a consistent order. The order of entries is established to ensure that the updates to the state database are valid when they are committed to the network. Unlike a cryptocurrency blockchain system (e.g., Bitcoin, etc.) where ordering occurs through the solving of a cryptographic puzzle, or mining, in this example the parties of the distributed ledger may choose the ordering mechanism that best suits that network.

Referring to FIG. 6D, a block 682A (also referred to as a data block) that is stored on the blockchain and/or the distributed ledger may include multiple data segments such as a block header 684A to 684n, transaction specific data 686A to 686n, and block metadata 688A to 688n. It should be appreciated that the various depicted blocks and their contents, such as block 682A and its contents are merely for purposes of an example and are not meant to limit the scope of the example embodiments. In some cases, both the block header 684A and the block metadata 688A may be smaller than the transaction specific data 686A which stores entry data; however, this is not a requirement. The block 682A may store transactional information of N entries (e.g., 100, 500, 1000, 2000, 3000, etc.) within the block data 690A to 690n. The block 682A may also include a link to a previous block (e.g., on the blockchain) within the block header 684A. In particular, the block header 684A may include a hash of a previous block's header. The block header 684A may also include a unique block number, a hash of the block data 690A of the current block 682A, and the like. The block number of the block 682A may be unique and assigned in an incremental/sequential order starting from zero. The first block in the blockchain may be referred to as a genesis block which includes information about the blockchain, its members, the data stored therein, etc.

The block data 690A may store entry information of each entry that is recorded within the block. For example, the entry data may include one or more of a type of the entry, a version, a timestamp, a channel ID of the distributed ledger, an entry ID, an epoch, a payload visibility, a smart contract executable code path (deploy tx), a smart contract executable code name, a smart contract executable code version, input (smart contract executable code and functions), a client (creator) identify such as a public key and certificate, a signature of the client, identities of endorsers, endorser signatures, a proposal hash, smart contract executable code events, response status, namespace, a read set (list of key and version read by the entry, etc.), a write set (list of key and value, etc.), a start key, an end key, a list of keys, a Merkel tree query summary, and the like. The entry data may be stored for each of the N entries.

In some embodiments, the block data 690A may also store transaction specific data 686A which adds additional information to the hash-linked chain of blocks in the blockchain. Accordingly, the data 686A can be stored in an immutable log of blocks on the distributed ledger. Some of the benefits of storing such data 686A are reflected in the various embodiments disclosed and depicted herein. The block metadata 688A may store multiple fields of metadata (e.g., as a byte array, etc.). Metadata fields may include signature on block creation, a reference to a last configuration block, an entry filter identifying valid and invalid entries within the block, last offset persisted of an ordering service that ordered the block, and the like. The signature, the last configuration block, and the orderer metadata may be added by the ordering service. Meanwhile, a committer of the block (such as a blockchain node) may add validity/invalidity information based on an endorsement policy, verification of read/write sets, and the like. The entry filter may include a byte array of a size equal to the number of entries in the block data 610A and a validation code identifying whether an entry was valid/invalid.

The other blocks 682B to 682n in the blockchain also have headers, files, and values. However, unlike the first block 682A, each of the headers 684A to 684n in the other blocks includes the hash value of an immediately preceding block. The hash value of the immediately preceding block may be just the hash of the header of the previous block or may be the hash value of the entire previous block. By including the hash value of a preceding block in each of the remaining blocks, a trace can be performed from the Nth block back to the genesis block (and the associated original file) on a block-by-block basis, as indicated by arrows 692, to establish an auditable and immutable chain-of-custody.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

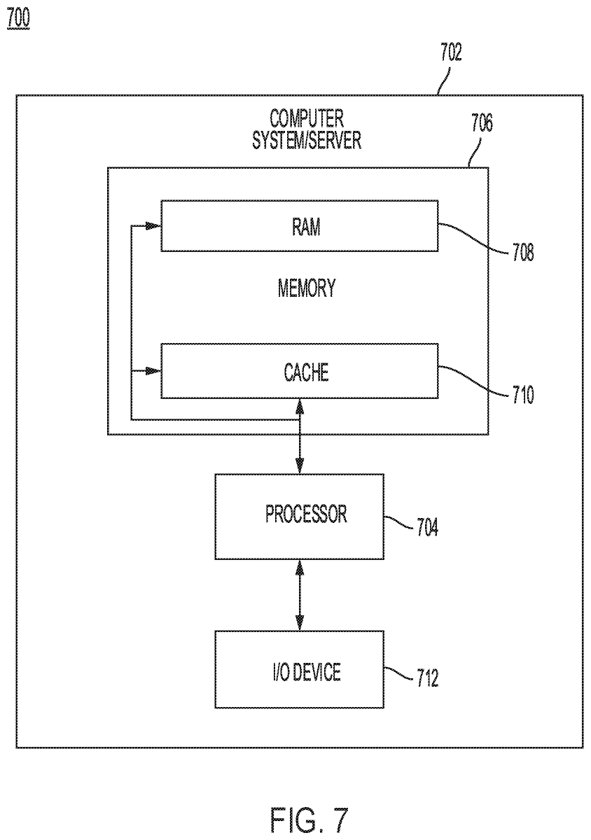

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 7 illustrates an example computer system architecture 700, which may represent or be integrated in any of the above-described components, etc.

FIG. 7 is not intended to suggest any limitation as to the scope of use or functionality of embodiments of the application described herein. Regardless, the computing node 700 is capable of being implemented and/or performing any of the functionality set forth hereinabove.

In computing node 700 there is a computer system/server 702, which is operational with numerous other general purpose or special purpose computing system environments or configurations. Examples of well-known computing systems, environments, and/or configurations that may be suitable for use with computer system/server 702 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 702 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 702 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 702 in cloud computing node 700 is shown in the form of a general-purpose computing device. The components of computer system/server 702 may include, but are not limited to, one or more processors or processing units 704, a system memory 706, and a bus that couples various system components including system memory 706 to processor 704.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 702 typically includes a variety of computer system readable media. Such media may be any available media that is accessible by computer system/server 702, and it includes both volatile and non-volatile media, removable and non-removable media. System memory 706, in one embodiment, implements the flow diagrams of the other figures. The system memory 706 can include computer system readable media in the form of volatile memory, such as random-access memory (RAM) 708 and/or cache memory 710. Computer system/server 702 may further include other removable/non-removable, volatile/non-volatile computer system storage media. By way of example only, memory 706 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 706 may include at least one program product having a set (e.g., at least one) of program modules that are configured to carry out the functions of various embodiments of the application.

Program/utility, having a set (at least one) of program modules, may be stored in memory 706 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 702 may also communicate with one or more external devices via an I/O device 712 (such as an I/O adapter), which may include a keyboard, a pointing device, a display, a voice recognition module, etc., one or more devices that enable a user to interact with computer system/server 702, and/or any devices (e.g., network card, modem, etc.) that enable computer system/server 702 to communicate with one or more other computing devices. Such communication can occur via I/O interfaces of the device 712. Still yet, computer system/server 702 can communicate with one or more networks such as a local area network (LAN), a general wide area network (WAN), and/or a public network (e.g., the Internet) via a network adapter. As depicted, device 712 communicates with the other components of computer system/server 702 via a bus. It should be understood that although not shown, other hardware and/or software components could be used in conjunction with computer system/server 702. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
determining a test vehicle in motion is proximate to a transport-under-test in motion, wherein the test vehicle includes a calibration device, and the transport-under-test includes one or more sensors;
transmitting calibration results from the calibration device to the one or more sensors;
receiving a calibration result, via the calibration device, from the one or more sensors;
determining, via the test vehicle, an error with the one or more sensors based on the calibration result; and
calibrating, via the transport-under-test, the one or more sensors based on the error.

2. The method of claim 1, further comprising determining a location of a test-rig on the test vehicle.

3. The method of claim 1, further comprising determining a location of the calibration device on a test-rig on the test vehicle.

4. The method of claim 1, wherein the calibration result comprises at least one of a location, a speed and a heading of the test vehicle.

5. The method of claim 1, further comprising:
determining a test vehicle location; and
determining a transport-under-test location.

6. The method of claim 1, wherein the calibration device is at least one of passive and active.

7. The method of claim 1, further comprising determining at least one of a relative position, a relative speed and a relative heading of the test vehicle to the transport-under-test.

8. A system, comprising:
a test vehicle that includes a calibration device;
a transport-under-test that includes one or more sensors;
a proximity detector electrically coupled with the transport-under-test, that determines the test vehicle in motion is proximate to the transport-under-test in motion;
a transmitter responsive to the calibration device, that transmits a calibration result to the one or more sensors; and
a receiver responsive to the one or more sensors, that receives the calibration result, via the calibration device;
wherein the test vehicle determines an error with the one or more sensors based on the calibration result; and
wherein the transport-under-test calibrates the one or more sensors based on the error.

9. The system of claim 8, further comprising:
a test-rig coupled to the test vehicle, wherein the coupling of the test-rig to the test vehicle determines a location of the test-rig on the test vehicle.

10. The system of claim 8, further comprising:
a test-rig coupled to the test vehicle; and
wherein the calibration device is coupled to the test-rig, and
wherein the coupling of the calibration device to the test-rig determines a location of the calibration device on the test-rig.

11. The system of claim 8, wherein the calibration result comprises at least one of a location, a speed and a heading of the test vehicle.

12. The system of claim 8, further comprising;
a test vehicle spatial location sensor that determines a test vehicle location; and
a transport spatial location sensor that determines a transport-under-test location.

13. The system of claim 8, wherein the calibration device is at least one of passive and active.

14. The system of claim 8, wherein a transport-under-test processor further determines at least one of a relative position, a relative speed and a relative heading of the test vehicle to the transport-under-test.

15. A non-transitory computer readable medium comprising instructions, that when read by a processor, cause the processor to perform:
determining a test vehicle in motion is proximate to a transport-under-test in motion, wherein the test vehicle includes a calibration device, and the transport-under-test includes one or more sensors;
transmitting a calibration result from the calibration device to the one or more sensors;
receiving the calibration result, via the calibration device, from the one or more sensors;
determining, via the test vehicle, an error with the one or more sensors based on the calibration result; and
calibrating, via the transport-under-test, the one or more sensors based on the error.

16. The non-transitory computer readable medium of claim 15, further comprising determining a location of a test-rig on the test vehicle.

17. The non-transitory computer readable medium of claim 15, further comprising determining a location of the calibration device on a test-rig on the test vehicle.

18. The non-transitory computer readable medium of claim 15, wherein the calibration result comprises at least one of a location, a speed and a heading of the test vehicle.

19. The non-transitory computer readable medium of claim 15, further comprising detecting a proximity of the test vehicle to the transport-under-test.

20. The non-transitory computer readable medium of claim 15, wherein the calibration device is at least one of passive and active.
